(19) United States
(12) Patent Application Publication
(10) Pub. No.: US 2009/0073130 A1
(43) Pub. Date: Mar. 19, 2009

(54) DEVICE HAVING COVER WITH INTEGRALLY FORMED SENSOR

(75) Inventors: Douglas Weber, Cupertino, CA (US); Stephen P. Zadesky, Cupertino, CA (US)

Correspondence Address: APPLE c/o MOFO NOVA, 1650 TYSONS BLVD., SUITE 300, MCLEAN, VA, 22102, US

(73) Assignee: Apple Inc., Cupertino, CA (US)

(21) Appl. No.: 11/856,530

(22) Filed: Sep. 17, 2007

(51) Int. Cl. G06F 3/041

(52) U.S. Cl. 345/173

(57) ABSTRACT

A touch sensing device is disclosed. According to an example of the disclosure, the touch sensing device may include a cover having a touchable surface and a touch sensor integrally formed on a surface of the cover opposite the touchable surface. The touch sensing device may use the cover as a mount and a medium to connect to a processor, in addition to the cover's established functions to protect the sensing device's circuitry and to provide an aesthetic surface.

### FIELD OF THE DISCLOSURE

The disclosure of the present application relates to sensing devices and, more particularly, to touch sensing devices.

### BACKGROUND

FIG. 1 is a diagram of an example of a commonly used touch sensing device. A touch sensing device is a mechanism through which a user may interact by touch with an electronic device. The sensing device is capacitance-based, in which a user touches, nearly touches, or comes within close proximity to the sensing device, such that a capacitance forms between the user's body part and the sensing device. The sensing device may then measure the formed capacitance, determine the location of the user's touch based on the measurement, and cause the electronic device to carry out an operation, e.g., a cursor motion, based on the determination.

In FIG. 1, touch sensing device 100 includes touch sensor 120 mounted on circuit board 130. Sensor 120 includes either a plurality of small metal sensors or a single metal sensor partitioned into sensing zones. Sensing device 100 includes cover 110 to protect sensor 120 from the user's touch and to provide a smooth surface for the user. Since the user's body is an electrical conductor, upon the user touching cover 110 with hand 160, for example, a capacitance forms between conductive hand 160 and metal sensor 120. Sensor 120 detects the capacitance caused by the touch, generates a detection signal, and transmits that signal through circuit board 130 to processor 140. Sensor 120 electrically connects through circuit board 130 to processor 140 via contacts 150. Processor 140 then determines the location of the touch and causes the electronic device having sensing device 100 to act.

An established function of a device cover, such as the cover in a touch sensing device, is to protect the underlying device components from contamination or damage from the outside and/or from component movement or detachment from the inside. Another established function of the cover is to provide an aesthetic device surface, e.g., a surface having textual or graphical information to the user or a surface with a smooth look or feel. The cover is limited to either one or both of these functions and nothing more.

An established function of a device circuit board, such as the circuit board in a touch sensing device, is to provide a mount for the touch sensor. Another established function of the circuit board is to provide a medium to electrically connect via contacts the sensor to the processor, which may be mounted either on another circuit board or on the sensor's circuit board. In the case of a touch sensing device, the circuit board is limited to these functions and nothing more. Other functions of the electronic device having the sensing device are carried out by circuitry mounted on other circuit boards in the electronic device.

Therefore, the effectiveness of a touch sensing device, having such limited established functionality of the cover and the circuit board, may be minimal when compared to the bulk, weight, complexity, and/or cost that these components, in particular the circuit board, add to the electronic device.

### SUMMARY

In order to improve the effectiveness of the touch sensing device, the present disclosure teaches touch sensing devices that combine, into the cover, the established functionality of both the circuit board and the cover by integrally forming the touch sensor on the under-surface of the cover, i.e., the surface opposite the surface that the user touches (the touchable surface). As such, the cover becomes the sensing device's circuit board. The need for the original circuit board is eliminated. This results in a lighter, less expensive, and simpler touch sensing device than those commonly used.

For example, the touch sensing device may include the cover with a touchable surface and the touch sensor integrally formed on the cover surface opposite the touchable surface. The cover may provide mounting for the sensor and a medium to electrically connect via contacts the sensor and the processor, in addition to protecting the sensor from the user's touch and providing an aesthetic surface for the user.

For example, the touch sensing device may include a top cover with a touchable surface, a bottom cover, and a touch sensor. The touch sensor may be integrally formed on at least the surface of the top cover opposite the touchable surface and disposed between the top and bottom covers. The top and/or bottom covers may then provide mounting for the sensor and a medium to electrically connect via contacts the sensor and the processor, in addition to the top cover protecting the sensor from the user's touch and either or both covers providing an aesthetic surface for the user.

For example, the touch sensing device may include an encapsulating cover with a cavity and touchable surface and a touch sensor. The touch sensor may be injected into the cavity of the cover and molded to be disposed on at least a portion of the cavity closest to the cover's touchable surface. The encapsulating cover may then provide mounting for the sensor and a medium to electrically connect via contacts the sensor and the processor, in addition to protecting the sensor from the user's touch and providing an aesthetic surface for the user.

The methods of the present disclosure may include a method of making a touch sensing device and a method of using the device.

### BRIEF DESCRIPTION OF THE DRAWINGS

FIG. 1 is a diagram of an example of a commonly used sensing device.

FIG. 2 is a diagram of an example of a sensing device.

FIG. 3 is a diagram of an example of a device with a sensing device.

FIGS. 4A, 4B, and 4C are diagrams of respective front, back, and exploded views of an example of a sensing device.

FIGS. 5A, 5B, and 5C are diagrams of respective front, back, and exploded views of an example of a sensing device with radial contact pads.

FIGS. 6A, 6B, and 6C are diagrams of respective front, back, and exploded views of an example of a sensing device with linear contact pads.

FIG. 7 is a diagram of an example of a sensing device with a multi-layered cover.

FIG. 8 is a diagram of an example of a sensing device with an adhesive layer.

FIG. 9 is a diagram of an example of a sensing device with top and bottom covers.

FIG. 10 is a diagram of an example of a sensing device with an encapsulating cover.

FIG. 11 is a diagram of an example of a device with a sensing device.

### DETAILED DESCRIPTION

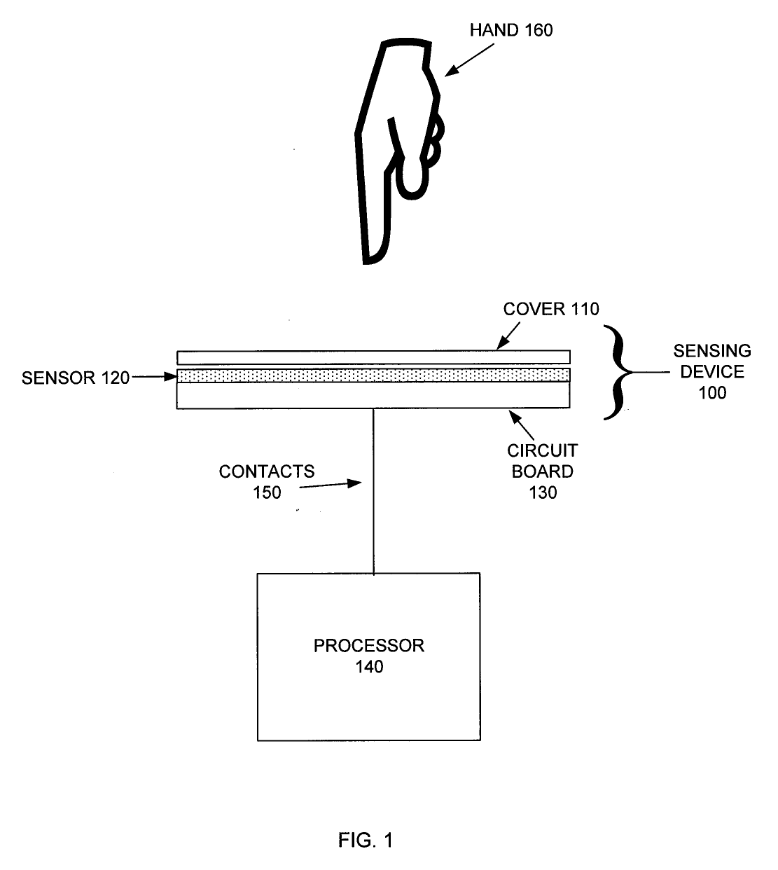

The present disclosure teaches a touch sensing device that provides a cover on which a touch sensor is integrally formed. This integral formation allows the cover to function as a mount and a connection medium for the sensor in the way that, traditionally, a sensing device's circuit board has. The cover also maintains its traditional functions to protect the sensor and provide an aesthetic surface. As such, the traditional sensing device's circuit board is eliminated. This results in a lighter, less expensive, and simpler touch sensing device that provides at least the same level of performance as the commonly used touch sensing device illustrated in FIG. 1.

In FIG. 1, cover 110 provides the established functions of protecting sensor 120 from the user's touch with hand 160 and providing a smooth surface to the touch, but nothing more. Circuit board 130 provides the established functions of mounting touch sensor 120 and providing a medium to electrically connect sensor 120 and processor 140 via contacts 150, but nothing more. Optionally, circuit board 130 may also mount processor 140. However, as can be seen in FIG. 1, the bulk and weight of sensing device 100 is increased with the presence of both cover 110 and circuit board 130. Additionally, the cost of sensing device 100 is increased due to circuit board 130. Furthermore, just by virtue of having both cover 110 and circuit board 130, the complexity of sensing device 100 is increased.

Circuit board 130 is the established way to mount touch sensor 120, as shown in FIG. 1, because the processes for placing electrical components on circuit boards and making electrical contact with other components are well-known and can be performed easily with known fabrication equipment. Therefore, establishing new ways to mount electrical components and provide electrical contacts have generally been ignored, though they may be an improvement over the established way.

In some cases, circuit board 130 is a flexible circuit board, which is a printed circuit board that has a flexible structure, e.g., made of plastic, upon which circuitry may be disposed. The flexible circuit board serves as a medium for mounting conductive traces, conductive pads, and/or conductive lines that form touch sensor 120 and for electrically connecting sensor 120 and processor 140. A flexible circuit board is generally used in an electronic device that is flexible or is space-limited so that the circuit board may be bent, for example. Because of its flexible nature, this board is generally preferred in sensing devices. However, its cost is slightly higher than that of the traditional printed circuit board.

In other cases, circuit board 130 is a traditional printed circuit board, which has a rigid structure upon which circuitry may be disposed. A printed circuit board is generally used in an electronic device in which there are neither flexibility requirements nor space limitations.

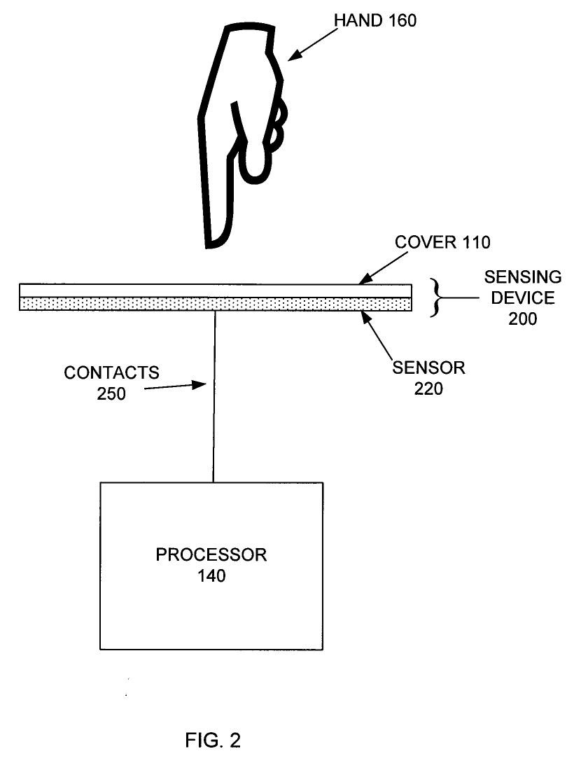

FIG. 2 is an example of a touch sensing device according to the present disclosure that is different from the commonly used device of FIG. 1. Touch sensing device 200 may include touch sensor 220 and cover 110. Sensor 220 may include a plurality of small metal sensors or a single metal sensor partitioned into sensing zones. Cover 110 may include any material, such as plastic, plastic resin, or any suitable polymerizable compound, compatible with sensor 220 and capable of sensor 220 being integrally formed thereon. Cover 110 may protect sensor 220 from the user's touch and provide a smooth surface for the user. Cover 110 may also mount sensor 220 and provide a connection medium for sensor 220 to processor 140. Sensor 220 may be integrally formed on the under-surface of cover 110, i.e., the surface that is opposite to the surface that the user touches (the touchable surface). Upon the user touching cover 110 with hand 160, for example, a capacitance may form between conductive hand 160 and metal sensor 220. Sensor 220 may detect the capacitance caused by the touch, generate a detection signal, and transmit that signal to processor 140 via contacts 250. Processor 140 may then determine the location of the touch and cause the electronic device having sensing device 200 to act.

Here, cover 110 provides the functionality of a sensing device's circuit board, e.g., the circuit board of FIG. 1, and its own functionality. Sensor 220 need not have a separate circuit board, but may use cover 110 as its circuit board. It is possible to use cover 110 as the circuit board for sensing device 200 because cover 110 can be made of the same or similar material as that of the now-eliminated circuit board, i.e., a material chemically and electrically compatible with the metals of sensor 220 and structurally capable of supporting sensor 220 To do so, cover 110 may be formed, sensor 220 integrally formed on cover 110, and electrical connection via contacts 250 made between sensor 220 and processor 140.

Sensor 220 may be integrally formed on the under-surface of cover 110 in a variety of ways, which includes, but is not limited to, the following examples. Sensor 220 may be printed directly onto the under-surface of cover 110 with conductive ink according to any known printing method to form conductive lines, pads, and/or traces. Or sensor 220 may be plated directly onto the under-surface of cover 110 with conductive plating according to any known plating method to form conductive lines, pads, and/or traces. Or sensor 220 may be formed out of a metal sheet stamped, cut, or etched into conductive lines, pads, and/or traces and directly placed onto the under-surface of cover 110 using 2-sided tape, glue, heat, or any suitable component or method capable of adhering sensor 220 to cover 110 in an integral formation. With a proper resistance maintained in integrally-formed sensor 220, sufficient touch sensing may be realized. For example, sensor 220 with a resistance of less than 16 ohms from a pad to the end of a trace may provide sufficient touch sensing. The printed, plated, and metal sheeted patterns that comprise sensor 220 on cover 110 may be different from those formed on an upper surface of the circuit board of FIG. 1 to account for the under-surface formation in sensing device 200.

Cover 110 may be formed using any known molding method, which includes, but is not limited to, the following examples. Cover 110 may be formed using shot injection molding in which molten material is shot (or injected) into a cavity of a mold. When the material cools, the mold may open and eject the molded material. In some cases, cover 110 may be made from multiple molds, in which case double shot injection molding may be used. Double shot injection molding may include the above described molding step. However, rather than eject the molded material after the material cools, a second mold may be placed on the material and molten material shot into the cavity of the second mold. After the second material cools, the mold may open and the doubly-molded material be ejected. The materials used in the first and second molds may be the same or different. Cover 110 may be either rigid or flexible, depending on its application. The structure of cover 110 may be different from that of the cover of FIG. 1 to account for the under-surface formation thereon of sensor 220.

Contacts 250 may be formed using any known fabrication method and used to electrically connect sensor 220 and processor 140. Contacts 250 may reside on the processor's or another circuit board or in any suitable position to electrically contact processor 140 and may extend in a suitable manner so as to also contact sensor 220, thereby electrically connecting sensor 220 and processor 140. Examples of contacts may include fixed pins, pogo pins, hot bar solder, solder balls, and any other suitable components. The configuration of contacts 250 may be different from that of the contacts of FIG. 1 to account for the under-surface formation of sensor 220 on cover 110, rather than the more traditional formation on an upper surface of a circuit board.

Where a traditional circuit board optionally mounts both a sensor and the sensor's processor, the circuit board may also be eliminated, with the sensor mounted on the under-surface of the cover as described in FIG. 2 and the processor mounted on another circuit board of the electronic device housing the touch sensing device, e.g., on the main circuit board of the electronic device.

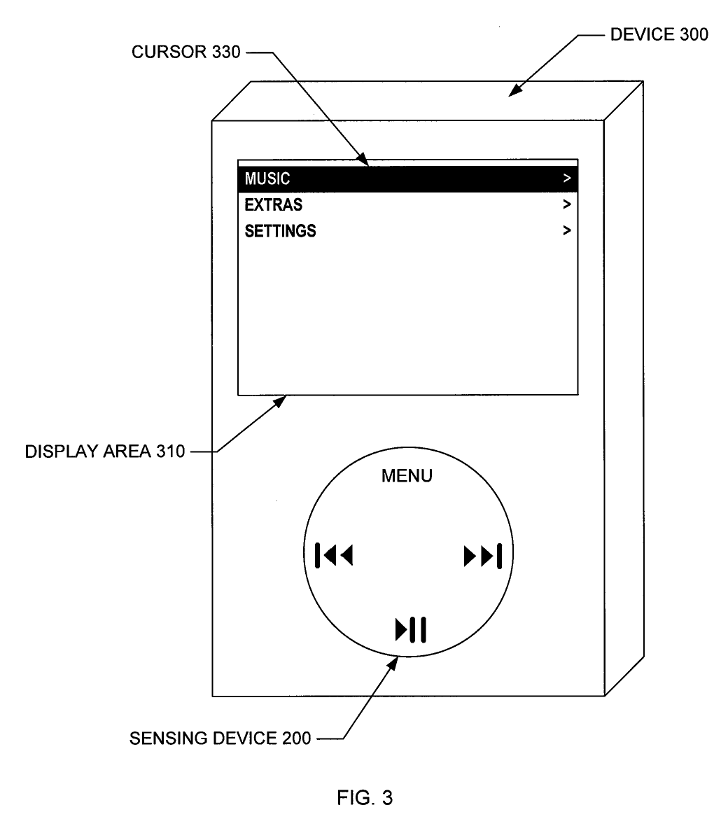

FIG. 3 is an example of a device utilizing a touch sensing device. Device 300 may include display area 310, in which a graphical user interface (GUI) displays a menu of selectable items identified as “music” “extras” and “settings,” and touch sensing device 200, which shows molded text “menu” and directional symbols. As a user touches sensing device 200, cursor 330 may highlight the “music” item in the GUI. As the user moves a finger rotationally around sensing device 200, cursor 330 may highlight the other items displayed in the GUI.

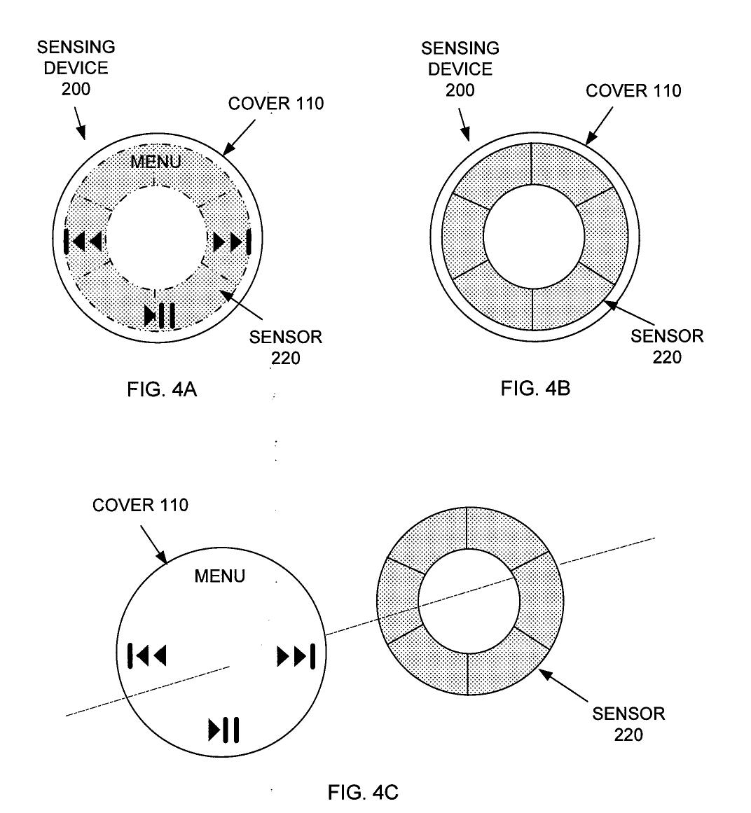

FIGS. 4A, 4B, and 4C depict different views of an example touch sensing device. Touch sensing device 200 may include cover 110 and touch sensor 220, as described previously. Sensor 220 may be integrally formed on the under-surface of cover 110. FIG. 4A shows a front view of sensing device 200. Here, cover 110 is round and sensor 220 is doughnut-shaped to direct the user to touch on sensing device 200 in a rotational manner. As such, sensor 220 is configured to be positioned at the likely touch areas.

FIG. 4B shows a back view of sensing device 200. As seen here, sensor 220 may include, but is not limited to, six (6) small metal sensors. Alternatively, sensor 220 may include a single metal sensor partitioned into any number of sensing zones. Each sensor of sensor 220 may provide coverage for a particular touch area. The sensor that covers the area of cover 110 where the user touches may detect the capacitance and generate the detection signal. Each sensor of sensor 220 may connect to at least one electrical contact (not shown) by which it can transmit the generated detection signal to the processor. The processor may determine the location of the touch based on which sensor of sensor 220 sent the detection signal.

FIG. 4C shows an exploded view of sensing device 200.

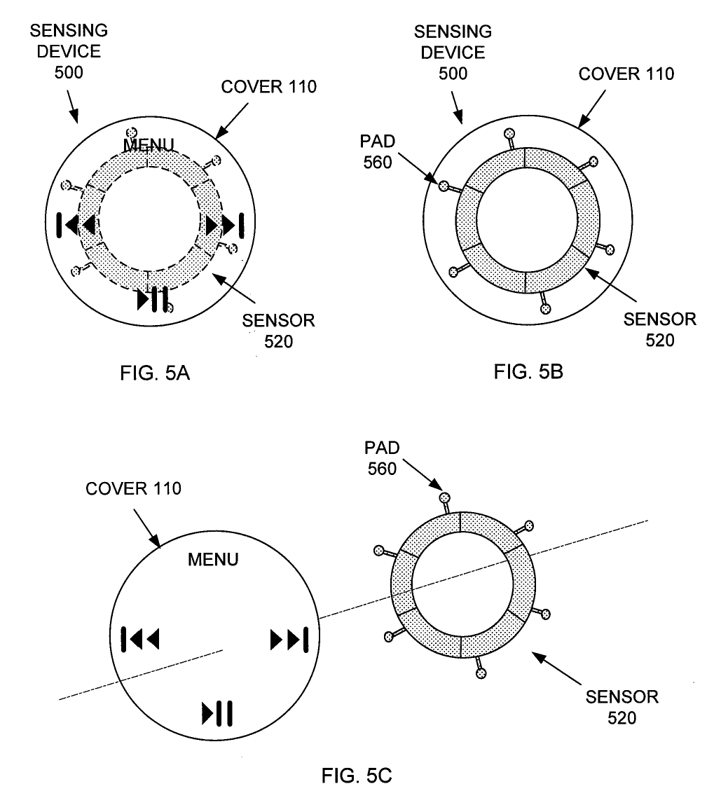

FIGS. 5A, 5B, and 5C depict different views of another example touch sensing device. Touch sensing device 500 may include cover 110 and touch sensor 520. Sensor 520 may be integrally formed on the under-surface of cover 110. FIG. 5A shows a front view of sensing device 500. Here, cover 110 is round and sensor 520 is doughnut-shaped with radial pads 560 attached thereto.

FIG. 5B shows a back view of sensing device 500. As seen here, sensor 520 may include, but is not limited to, six (6) small metal sensors. Alternatively, sensor 520 may include a single metal sensor partitioned into any number of sensing zones. Each sensor of sensor 520 may also include pad 560 attached thereto via short leads. Pad 560 may connect to at least one electrical contact (not shown) by which that sensor's generated detection signal may be transmitted to the processor. The processor may determine the location of the touch based on which pad 560 sent the detection signal.

FIG. 5C shows an exploded view of sensing device 500.

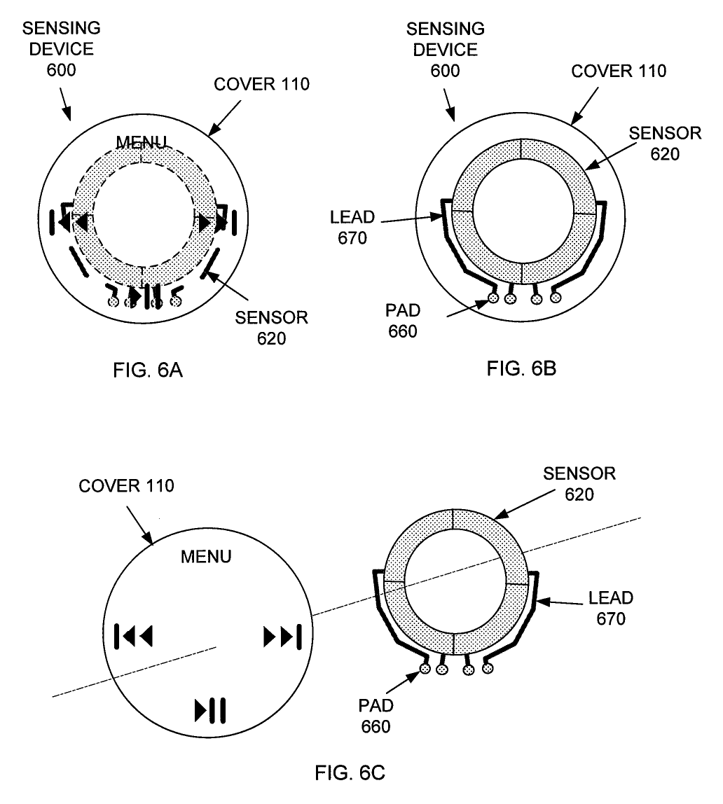

FIGS. 6A, 6B, and 6C depict different views of still another example touch sensing device. Touch sensing device 600 may include cover 110 and touch sensor 620. Sensor 620 may be integrally formed on an under-surface of cover 110. FIG. 6A shows a front view of sensing device 600. Here, cover 110 is round and sensor 620 is doughnut-shaped with linear pads 660 attached thereto via leads 670.

FIG. 6B shows a back view of sensing device 600. As seen here, sensor 620 may include, but is not limited to, four (4) small metal sensors. Alternatively, sensor 620 may include a single metal sensor partitioned into any number of sensing zones. Each sensor of sensor 620 may also include pad 660 attached thereto via lead 670. Pad 660 may connect to at least one electrical contact (not shown) by which that sensor's generated detection signal may be transmitted to the processor. The processor may determine the location of the touch based on which pad 660 sent the detection signal. Here, pads 660 are positioned in a linear arrangement. This linear arrangement might be used for ease of connection when the contacts are similarly arranged, for example.

FIG. 6C shows an exploded view of sensing device 600.

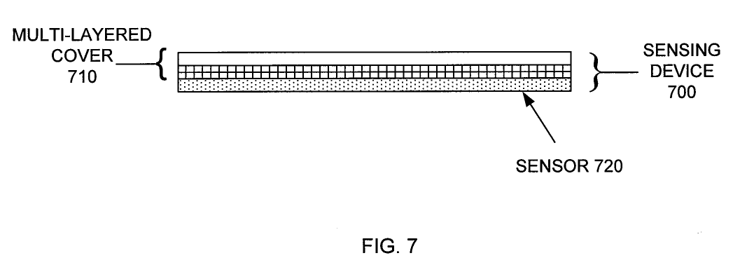

FIG. 7 is an example of a touch sensing device. Touch sensing device 700 may include multi-layered cover 710 and touch sensor 720. Sensor 720 may be as described in any of the previous examples. Cover 710 may include two or more stacked layers, where the layers may be made of the same or different material. The layers may be held together using a form of adhesive or attachment or molded together into a single piece. A top layer may include a touchable surface. A second layer may be disposed on the under-surface of the top layer, i.e., the surface opposite the touchable surface. A third layer may be disposed on the under-surface of the second layer and so on. Sensor 720 may be integrally formed on the under-surface of the bottommost layer of cover 710.

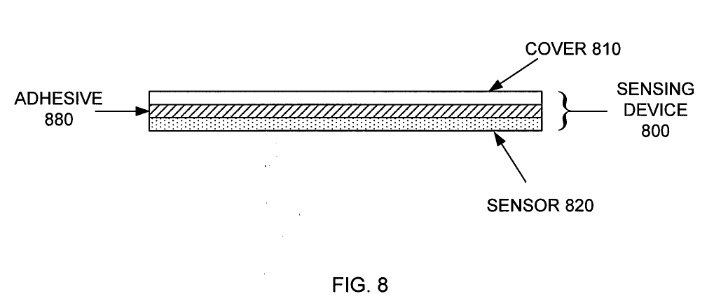

FIG. 8 is an example of a touch sensing device. Touch sensing device 800 may include cover 810, touch sensor 820, and adhesive 880. Sensor 820 may include a stamped, cut, or etched metal sheet, described previously. Cover 810 may include a touchable surface. Adhesive 880 may be placed on the under-surface of cover 810, i.e., the surface opposite the touchable surface, to integrally form sensor 820 on cover 810.

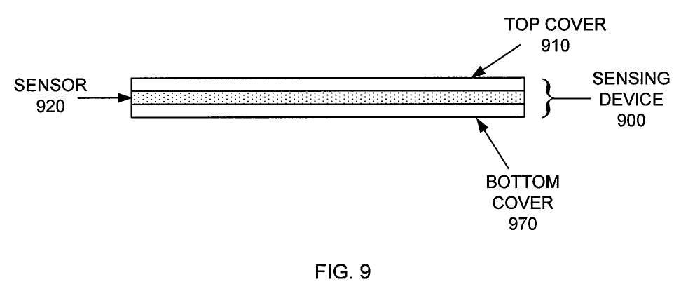

FIG. 9 is an example of a touch sensing device. Touch sensing device 900 may include top cover 910, touch sensor 920, and bottom cover 970. Sensor 920 may be as described in any of the previous examples. Top cover 910 may include a touchable surface. Top cover 910 and bottom cover 970 may be the same or different material. Sensor 920 may be integrally formed on either cover and disposed between them, where sensor 920 may be disposed on the under-surface of top cover 910, i.e., the surface opposite the touchable surface, and bottom cover 970 may be disposed on the under-surface of sensor 920. Optionally, the ends of covers 910 and 970 may be sealed to enclose sensor 920 and pins (not shown) connected to sensor 920 through bottom cover 910. The pins would connect sensor 920 to at least one electrical contact (not show) by which a generated detection signal would be transmitted to the processor.

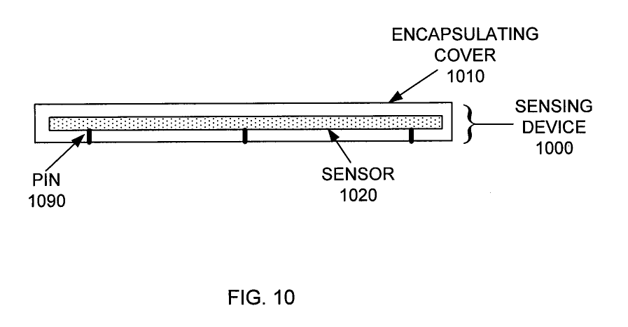

FIG. 10 is an example of a touch sensing device. Touch sensing device 1000 may include encapsulating cover 1010 and touch sensor 1020. Encapsulating cover 1010 may include a cavity and have a touchable surface. The cavity may form a mold of sensor 1020, including pin holes through the bottom of cover 1010. A molten metal may be injected into the cavity and pin holes of cover 1010 and cooled to form molded sensor 1020 with pins 1090. Sensor 1020 may be molded to be disposed on at least a portion of the roof of the cavity, i.e., closest to the touchable surface. Pins 1090 may connect to at least one electrical contact (not shown) by which a generated detection signal may be transmitted to the processor.

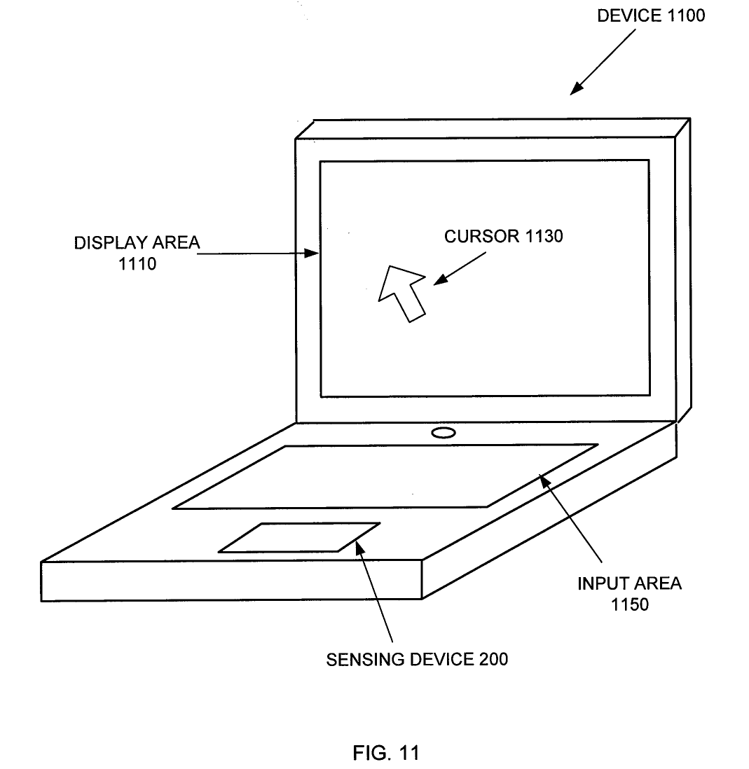

FIG. 11 is an example of a device utilizing a touch sensing device. Device 1100 may include input area 1150, through which a user inputs information to device 1100, display area 1110, which displays information to the user, and touch sensing device 200. As the user touches sensing device 200, cursor 1130 may navigate display area 1110. The position and direction of cursor 1130 may be determined by where and how the user touches sensing device 200.

The present disclosure is not limited to the configurations of the touch sensing devices described here, but rather may include any configuration capable of touch sensing in accordance with the teachings of the present disclosure.

What is claimed is:

1. A sensing device comprising:
at least one layer having a touchable surface; and
a sensor integrally formed on a surface of the layer opposite the touchable surface.

2. The device of claim 1, wherein the at least one layer comprises at least one plastic.

3. The device of claim 1, wherein the sensor comprises at least one of a conductive line, a conductive pad, and a conductive trace.

4. The device of claim 1, wherein the sensor is printed onto the surface of the layer opposite the touchable surface.

5. The device of claim 1, wherein the sensor is plated onto the surface of the layer opposite the touchable surface.

6. The device of claim 1, wherein the sensor is fabricated as a metal sheet and adhered to the surface of the layer opposite the touchable surface.

7. The device of claim 6, further comprising an adhesive.

8. The device of claim 1, wherein the at least one layer comprises:
a first layer having the touchable surface; and
a second layer having a first surface disposed on the surface of the first layer opposite the touchable surface and having a second surface opposite the first surface,
wherein the sensor is integrally formed on the second surface of the second layer.

9. The device of claim 1, wherein the sensor comprises a plurality of individual sensors.

10. The device of claim 1, wherein the sensor is partitioned into sensing zones.

11. A sensing device comprising:
a layer with a cavity and a touchable surface; and
a sensor injectibly molded into the cavity,
wherein the sensor is formed on at least a portion of the cavity closest to the touchable surface.

12. The device of claim 11, wherein the layer includes pin holes.

13. The device of claim 11, wherein the sensor includes molded pins.

14. A sensing device comprising:
a first layer having a touchable surface;
a second layer; and
a sensor disposed between the first and second layers on at least a surface of the first layer opposite the touchable surface.

15. The device of claim 14, wherein the first and second layers comprise different material.

16. The device of claim 14, wherein the sensor is integrally formed on the surface of the first layer opposite the touchable surface.

17. The device of claim 14, wherein the sensor is integrally formed on a surface of the second layer facing the first layer.

18. A method comprising:
providing at least one layer having a touchable surface; and
providing a sensor integrally formed on a surface of the layer opposite the touchable surface.

19. A method comprising:
operating a sensing device comprising:
at least one layer having a touchable surface, and
a sensor integrally formed on a surface of the layer opposite the touchable surface.
